(19) United States
(12) Patent Application Publication
(10) Pub. No.: US 2003/0126263 A1
(43) Pub. Date: Jul. 3, 2003

(54) Multimedia load balancing architecture

(76) Inventors: Gregg Fenton, Northport, NY (US); Eddy Makkinje, Huntington, NY (US)

Correspondence Address: GARDERE WYNNE SEWELL LLP, Suite 3000, 1601 Elm Street, Dallas, TX, 75201-4767, US

(21) Appl. No.: 10/278,824

(22) Filed: Oct. 23, 2002

Related U.S. Application Data
(60) Provisional application No. 60/345,954, filed on Dec. 31, 2001.

(51) Int. Cl. G06F 15/173

(52) U.S. Cl. 709/226

(57) ABSTRACT

The present invention provides a system, method and apparatus for balancing multimedia message loading within a network (118). When a multimedia message is received at the load balancer (102), one of the two or more multimedia service relays (104) is selected to process the multimedia message. The load balancer (102) is communicably coupled to the two or more multimedia service relays (104) and the two more multimedia service servers (106). The multimedia message is then sent to the selected multimedia service relay (104) for processing. Thereafter, the processed multimedia message is received from the selected multimedia service relay (104), one of the two or more multimedia service servers (106) is selected to store the multimedia message on a message storage device (108) communicably coupled to the selected multimedia service server (106), and the processed multimedia message is sent to the selected multimedia service server (106).

### RELATED APPLICATIONS

This patent application claims priority to U.S. provisional patent application No. 60/345,954 filed on Dec. 31, 2001.

### BACKGROUND OF THE INVENTION

Short messaging service (“SMS”) has been very successful in the Global System for Mobile Communications (“GSM”) second generation system (“2G”). The success of SMS is due, in part, to the fact that all GSM capable devices support the SMS application level so that there is no need to check each device to determine whether or not its supports SMS applications. This easy to use service for non-real time text transmission between GSM users will be succeeded to in third generation (“3G”) mobile systems by a non-real time multimedia message service (“MMS”). The MMS will provide multimedia message capability instead of the text only capability of SMS.

Multimedia consists of one or more media elements, such as text, voice, image and video, and it is the combination of these media elements in an ordered synchronized manner that creates a multimedia presentation, which is also referred to as multimedia content. A non-real time multimedia message as observed by the user is a combination of one or more different media elements in a multimedia presentation that can be transferred between users without having to be transferred in real time.

With the popularity of the Internet and increased capability of personal computers, multimedia technology has and continues to rapidly develop to allow new capabilities, such as multimedia messages, games, presentations and services that are now considered to be a part of every day life. Moreover, the reduced size and increased capabilities of handheld devices, such as personal data assistants (“PDAs”), mobile phones and combinations thereof, have made the delivery of multimedia content to such devices more of a possibility. Efficient and effective delivery of multimedia content to such devices is not, however, a practical reality.

More specifically, current systems maintain a one-to-one mapping between multimedia service relays and multimedia service servers. In fact, many times the multimedia service relay and multimedia service server are combined into a single device. This one-to-one mapping increases system costs and is inefficient as a result of under utilized facilities. In addition, each multimedia service relay/server is assigned one or more addresses. As a result, the network has to redirect multimedia messages bound for a multimedia service relay/server that has either failed or is down for maintenance. There is, therefore, a need for a multimedia load balancing architecture that is flexible, scalable and provides high availability for processing multimedia messages.

### SUMMARY OF THE INVENTION

The present invention provides a flexible architecture that supports present and future multimedia messaging technologies and handles all message types and formats, such as fax, SMS, Multimedia, voicemail and e-mail, in a consistent manner regardless of message type or format. The present invention provides a multimedia load balancing architecture that is flexible, scalable and provides high availability for processing multimedia messages. The present invention also segments to the workload within the network and maximizes resource allocation and utilization. Moreover, the present invention allows a service provider to use a single address for multimedia messages, which transforms the physical nodes of the network into a virtual resource network that works as a single system regardless of physical location. This allows the physical configuration of the network to be changed seamlessly and transparently. The present invention reduces cost and improves efficiency by allowing a system operator to add or remove only the devices that are required and allowing the network devices to share common resources. The present invention can also be used for security and disaster recovery.

More specifically, the present invention provides a method for balancing multimedia message loading within a network having two or more multimedia service relays and two or more multimedia service servers. When a multimedia message is received at the ingress/egress device or load balancer for the network, one of the multimedia service relays is selected to process the multimedia message. The load balancer is communicably coupled to the two or more multimedia service relays and the two more multimedia service servers. The multimedia message is then sent to the selected multimedia service relay for processing. Thereafter, the processed multimedia message is received from the selected multimedia service relay, one of the multimedia service servers is selected to store the multimedia message on a message storage device communicably coupled to the selected multimedia service server, and the processed multimedia message is sent to the selected multimedia service server. The functionality described above can be implemented as a computer program embodied on a computer readable medium wherein each function is implemented as a code segment adapted to perform such function.

In addition, the present invention provides an apparatus (ingress/egress device or load balancer) that includes a communications interface, a processor and a memory. The communications interface is used to communicably couple the load balancer to at least the multimedia service relays and the multimedia service servers. The processor is communicably coupled to the communications interface and the memory. In operation, the processor receives a multimedia message via the communications interface, selects one of the multimedia service relays to process the multimedia message and sends the multimedia message to the selected multimedia service relay for processing via the communications interface. The processor then receives the processed multimedia message from the selected multimedia service relay via the communications interface, selects one of the multimedia service servers to store the multimedia message, and sends the processed multimedia message to the selected multimedia service server via the communications interface.

The present invention also provides a system for balancing multimedia loading within a network that includes an ingress/egress device or load balancer, two or more multimedia service relays communicably coupled to the load balancer, two or more multimedia service servers communicably coupled to the load balancer and a message storage device communicably coupled to each multimedia service server. The load balancer receives a multimedia message, selects one of the multimedia service relays to process the multimedia message and sends the multimedia message to the selected multimedia service relay for processing. The load balancer then receives the processed multimedia message from the selected multimedia service relay, selects one of the multimedia service servers to store the multimedia message on the message storage device and sends the processed multimedia message to the selected multimedia service server

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a block diagram of a Multimedia Messaging Service having a load balancer in accordance with one embodiment of the present invention;

FIG. 2 is a block diagram showing the components of a Multimedia Messaging Service having a load balancer in accordance with one embodiment of the present invention;

FIG. 3 is a block diagram showing the network connectivity Multimedia Messaging Service having a load balancer in accordance with one embodiment of the present invention;

FIG. 4 is a block diagram showing a single site Multimedia Messaging Service having a load balancer in accordance with one embodiment of the present invention;

FIG. 5 is a block diagram showing a multiple site Multimedia Messaging Service having a load balancer in accordance with one embodiment of the present invention; and

FIG. 6 is a block diagram showing a multiple site Multimedia Messaging Service having a load balancer in accordance with another embodiment of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. For example, in addition to telecommunications systems, the present invention may be applicable to other forms of communications or general data processing. Other forms of communications may include communications between networks, communications via satellite, or any form of communications not yet known to man as of the date of the present invention. The specific embodiments discussed herein are merely illustrative of specific ways to make and use the invention and do not limit the scope of the invention.

The present invention provides a flexible architecture that supports present and future multimedia messaging technologies and handles all message types and formats, such as fax, SMS, Multimedia, voicemail and e-mail, in a consistent manner regardless of message type or format. The present invention provides a multimedia load balancing architecture that is flexible, scalable and provides high availability for processing multimedia messages. The present invention also segments to the workload within the network and maximizes resource allocation and utilization. Moreover, the present invention allows a service provider to use a single address for multimedia messages, which transforms the physical nodes of the network into a virtual resource network that works as a single system regardless of physical location. This allows the physical configuration of the network to be changed seamlessly and transparently. The present invention reduces cost and improves efficiency by allowing a system operator to add or remove only the devices that are required and allowing the network devices to share common resources. The present invention can also be used for security and disaster recovery.

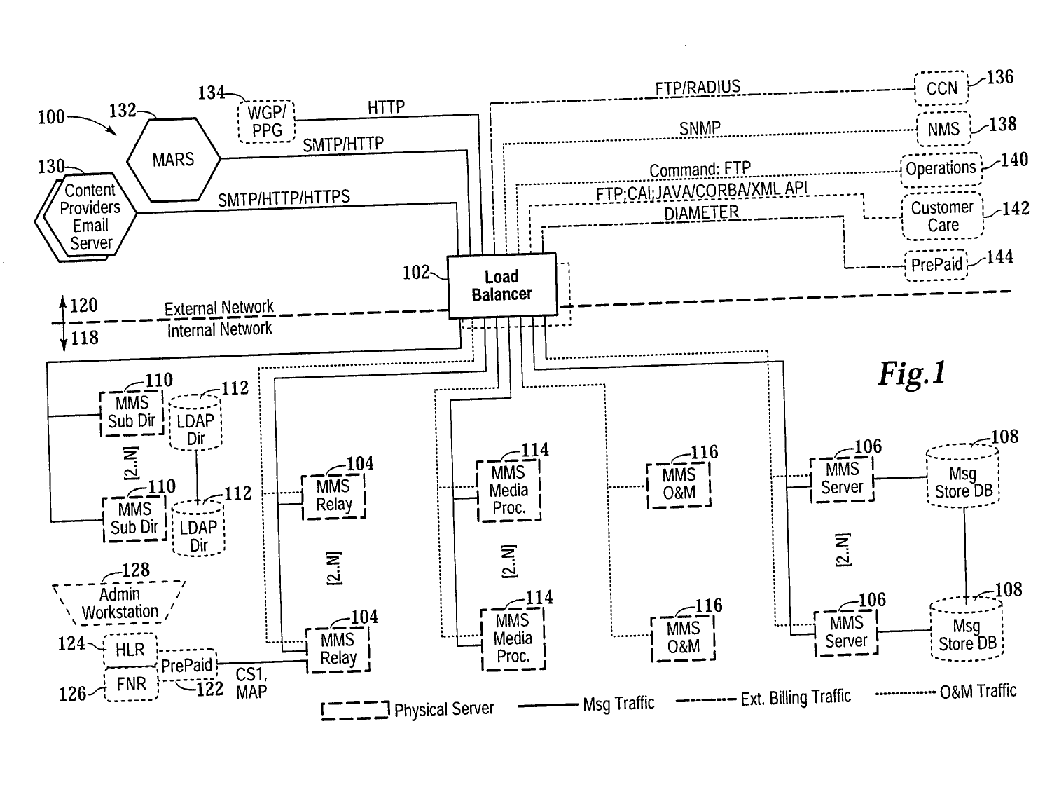

Referring to FIG. 1, a block diagram of a Multimedia Messaging Service (“MMS”) 100 having a load balancer 102 in accordance with one embodiment of the present invention is shown. The present invention provides a system for balancing multimedia loading using an ingress/egress device or load balancer 102 communicably coupled (message traffic and O&M traffic) to two or more multimedia service relays (“MMS Relay”) 104 and two or more multimedia service servers (“MMS Server”) 106. A message storage device or database 108 is communicably coupled to each MMS server 106. In addition, the load balancer 102 is communicably coupled (message traffic) to two or more multimedia subscriber directories (“MMS Sub. Dir.”) 110, each MMS Subscriber Directory 110 having a subscriber database 112, such as a LDAP directory database. The LDAP Database may be physically located within the physical embodiments or external to an existent LDAlP directory database. The load balancer 102 is also communicably coupled to two or more MMS Media Processors 114 (message traffic and O&M traffic) and two or more MMS O&M Servers 116 (O&M traffic). Note that two load balancers 102 will be typically used to provide redundancy for the system. The solid lines connecting the various elements in FIG. 1 represent message traffic; whereas, the dashed lines represent O&M traffic and the dash-dot-dot lines represent external billing traffic.

The ingress/egress device or load balancer 102 is responsible for multimedia traffic distribution within the internal network 118 (otherwise simply referred to as the network) and acts as a gateway for the transfer of multimedia messages between the network 118 and the one or more external networks 120. The load balancer 102 further segments the workload within the network 118 and provides a high availability system by maximizing resource allocation and resource utilization. Moreover, the load balancer 102 is identified by a single address, such as a domain name or Internet Protocol (“IP”) address. This single address can be used for subscribers or service providers. As a result, the one or more external networks 120 are mapped to the network 118 through the single virtual address of the load balancer 102. The load balancer 102, therefore, transforms the physical nodes (104, 106, etc.) of network 118 into a virtual resource network that works as a single system regardless of physical location. The physical nodes (104, 106, etc.) can be collocated or distributed around the world.

Accordingly, the load balancer 102 is used to set the logical aspects of the network 118, while at the same time allowing the physical configuration of the network 118 to be changed seamlessly and transparently with respect to the network 118 and the one or more external networks 120. This system reduces cost and increases efficiency by allowing the system operator to add or remove only those devices that are required. For example, a new MMS Server 106 does not have to be added each time a MMS Relay 104 is added. Moreover, the load balancer 102 allows the MMS Relays 104 and MMS Servers 106 to share common resources, such as the MMS Subscriber Directory 110, MMS Media Processors 114 and MMS O&M Servers 116. The load balancer 102 may also act as a security device for the network 118, e.g., providing a firewall between network 118 and the one or more external networks 120. For example, the load balancer 102 can reject protocols that are not defined or not known.

The ingress/egress device or load balancer 102 may include a communications interface, a processor and a memory. The communications interface is used to communicably couple the load balancer to at least the MMS Relays 104 and the MMS Servers 106. The processor is communicably coupled to the communications interface and the memory. In operation, the processor receives a multimedia message via the communications interface, selects one of the MMS Relays 104 to process the multimedia message and sends the multimedia message to the selected MMS Relay 104 for processing via the communications interface. The processor then receives the processed multimedia message from the selected MMS Relay 104 via the communications interface, selects one of the MMS Servers 106 to store the multimedia message, and sends the processed multimedia message to the selected MMS Server 106 via the communications interface.

As a result, the present invention provides a method for balancing multimedia message loading within a network 118 having two or more MMS Relays 104 and two or more MMS Servers 106. When a multimedia message is received at the ingress/egress device or load balancer 102 for the network 118, one of the MMS Relays 104 is selected to process the multimedia message. The multimedia message can be received from within the network 118 or received from the one or more external networks 120. As previously described, the load balancer 102 is communicably coupled to the two or more MMS Relays 104 and the two more MMS Servers 106. The multimedia message is then sent to the selected MMS Relay 104 for processing. Thereafter, the processed multimedia message is received from the selected MMS Relay 106, one of the MMS Servers 106 is selected to store the multimedia message on a message storage device 108 communicably coupled to the selected MMS Server 106, and the processed multimedia message is sent to the selected MMS Server 106.

The selection of the MMS Relay 104 and/or the MMS Server 106 can be based on many operational criteria, such as the location, loading and operational status of the devices (104 and 106). Moreover, the selection of the MMS Relay 104 and/or the MMS Server 106 can be based on one or more rules stored within a configuration table within the load balancer 102. These one or more rules can be designed to maximize resource allocation or resource utilization within the network 118 or implement a disaster recovery plan. For example, the load balancer 102 can seamlessly and transparently reroute multimedia message processing if one of the MMS Relays 104 fails or is out of service for maintenance. The present invention can also determine whether the multimedia message satisfies one or more security criteria and reject the multimedia message if it fails to satisfy one or more of these security criteria. As will be appreciated and understood by those skilled in the art, the functionality described above can be implemented as a computer program embodied on a computer readable medium wherein each function is implemented as a code segment adapted to perform such function.

Within the network 118, the MMS Relays 104 and MMS Servers 106 process and store multimedia messages, enable/disable MMS functions, personalize MMS based on user profile information, delete multimedia messages based on user profile or filtering information, perform media type and format conversions, convert messages from legacy messaging systems to multimedia format (e.g. facsimile to MM), convert multimedia messages to the appropriate message format for delivery on the one or more external networks 120 (e.g. multimedia to internet email), retrieve message content, forward multimedia messages, screen multimedia messages; negotiate MMS User Agent (not shown) terminal capabilities, check MMS User Agent (not shown) terminal availability, provide multimedia message notification to the MMS User Agents (not shown), generate call data records (“CDR”), provide address translation, hide addresses, manage the message properties on servers (e.g. voicemail or email server) integrated in the system, provide temporary and/or persistent storage of messages, ensure that messages are not lost until successfully delivered to another element, control the reply-charging feature of MMS, and other functions or services.

As previously described, the present invention allows the MMS Relays 104 and MMS Servers 106 to be loosely coupled and either collocated or distributed across the world. If the MMS Relay 104 and MMS Server 106 are separate physical entities, the message transfer between the MMS Relay 104 and MMS Server 106 may use Simple Mail Transfer Protocol (“SMTP”) and Post Office Protocol Version 3 (“POP3”)/Internet Message Acces Protocol (“IMAP”) or Hypertext Transfer Protocol (“HTTP”). If SMTP is used to upload and download multimedia messages to the MMS Server 106, then that same protocol can be used to transfer multimedia messages between different domains. The MMS Relays 104 are also communicably coupled to the Prepaid Server 122, Home Location Register (“HLR”) 124 and FNR 126. The MMS Relays 104 communicate with the Prepaid Server 122, HLR 124 and FNR 126 using CS1 or MAP. An administration workstation 128 can be used to monitor and configure the network 118.

The MMS Relay 104 is basically a state machine that processes the multimedia message based on either a standard process or customized process. Information and instructions contained in the MMS O&M Server 116, MMS Subscriber Directory 110, as well as the Prepaid Server 122, HLR 124 and FNR 126 may dictate how the MMS Relay 104 processes the multimedia message. For example, the MMS Subscriber Directory 110 and the MMS O&M Server 116 are used to make service distinctions between users. The MMS O&M Server 116 provides operator services to tailor how the MMS works for different subscriber groups, such as pre-paid, corporate, premium, economy, etc. The MMS O&M Server 116 may also value added services to the MMS users. Likewise, the MMS Sub. Dir 110 contains user related information such as subscription and configuration (e.g. user profile, subscription, operator services, HLR, etc.). The MMS Sub. Dir 110 may provide MMS user subscription information, information for the control of access to the MMS, information for the control of the extent of available service capability (e.g. server storage space), a set of rules how to handle incoming messages and their delivery, and information of the current capabilities of the user's terminal.

The load balancer 102 is also communicably coupled to one or more external networks 120. These external networks 120 may include content provider and e-mail servers 130, MARS 132, Wireless Application Protocol (“WAP”)/Push-Pull Gateway (“PPG”) 134, CCN 136, NMS 136, Operations Server 140, Customer Care Server 142, and Prepaid Server 144. The load balancer 102 can communicate (message traffic) with the content providers and e-mail servers 130 via SMTP, HTTP or Secure HTTP (“HTTPS”). The load balancer 102 can communicate (message traffic) with the MARS 132 via SMTP or HTTP. The load balancer 102 can communicate (message traffic) with the WGP/PPG 134 via HTTP. The load balancer 102 can communicate (external billing traffic) with the CCN 136 via File Transfer Protocol (“FTP”) or RADIUS. The load balancer 102 can communicate (O&M traffic) with the NMS 138 via SMTP. The load balancer 102 can communicate (O&M traffic) with the Operations Server 140 via Command:FTP. The load balancer 102 can communicate (O&M traffic) with the Customer Care Server 142 via FTP:CAI:JAVA, CORBA or XML API. The load balancer 102 can communicate (external billing traffic) with the Prepaid Server 144 via DIAMETER.

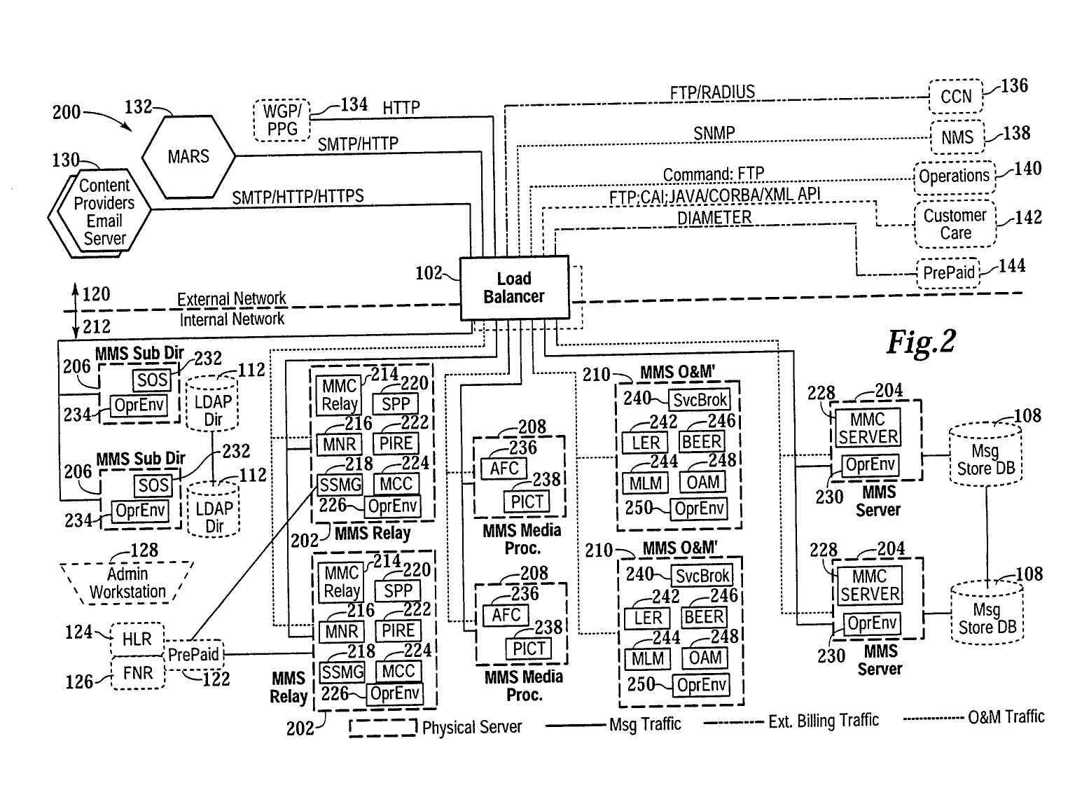

Now referring to FIG. 2, a block diagram showing the components of a MMS 200 having an ingress/egress device or load balancer 102 in accordance with one embodiment of the present invention is shown. The present invention provides a system for balancing multimedia loading using an ingress/egress device or load balancer 102 communicably coupled (message traffic and O&M traffic) to two or more MMS Relays 202 and two or more MMS Servers 204. A message storage device or database 108 is communicably coupled to each MMS server 106. In addition, the load balancer 102 is communicably coupled (message traffic) to two or more MMS Subscriber Directory 206, each MMS Subscriber Directory 206 having a subscriber database 112, such as a LDAP directory database. The load balancer 102 is also communicably coupled to two or more MMS Media Processors 208 (message traffic and O&M traffic) and two or more MMS O&M Servers 210 (O&M traffic). The load balancer 102 provides an interface between internal network 212 and one or more external networks 120. Note that two load balancers 102 will be typically used to provide redundancy for the system. The MMS Relays 104 are also communicably coupled to the Prepaid Server 122, HLR 124 and FNR 126. The MMS Relays 104 communicate with the Prepaid Server 122, HLR 124 and FNR 126 using CS1 or MAP. An administration workstation 128 can be used to monitor and configure the network 118. The basic functionality of the load balancer 102, MMS Relays 202, MMS Servers 204, MMS Sub. Dir 206, MMS Media Processor 208 and MMS O&M Server 210 are the same as previously described in reference to FIG. 1. The solid lines connecting the various elements in FIG. 2 represent message traffic; whereas, the dashed lines represent O&M traffic and the dash-dot-dot lines represent external billing traffic.

The load balancer 102 is also communicably coupled to one or more external networks 120. These external networks 120 may include content provider and e-mail servers 130, MARS 132, WAP/PPG 134, CCN 136, NMS 136, Operations Server 140, Customer Care Server 142, and Prepaid Server 144. The load balancer 102 can communicate (message traffic) with the content providers and e-mail servers 130 via SMTP, HTTP or HTTPS. The load balancer 102 can communicate (message traffic) with the MARS 132 via SMTP or HTTP. The load balancer 102 can communicate (message traffic) with the WGP/PPG 134 via HTTP. The load balancer 102 can communicate (external billing traffic) with the CCN 136 via FTP or RADIUS. The load balancer 102 can communicate (O&M traffic) with the NMS 138 via SMTP. The load balancer 102 can communicate (O&M traffic) with the Operations Server 140 via Command:FTP. The load balancer 102 can communicate (O&M traffic) with the Customer Care Server 142 via FTP:CAI:JAVA, CORBA or XML API. The load balancer 102 can communicate (external billing traffic) with the Prepaid Server 144 via DIAMETER.

The physical server representing the MMS Relay 202 includes an operating environment (“OprEnv”) 226 and the following modules: MMS Relay 214, MNR 216, SSMG 218, SPP 220, PIRE 222 and MCC 224. The physical server representing the MMS Server 204 includes a MMS Server module 228 and an operating environment (“OprEnv”) 230. The physical server representing the MMS Subscriber Directory 206 includes a SOS module 232 and an operating environment (“OprEnv”) 234. The physical server representing the MMS Media Processor 208 includes an AFC module 236 and a PICT module 238. The physical server representing the MMS O&M Server 210 includes an operating environment (“OprEnv”) 250 and the following modules: SvcBrok 240, LER 242, MLM 244, BEER 246 and OAM 248.

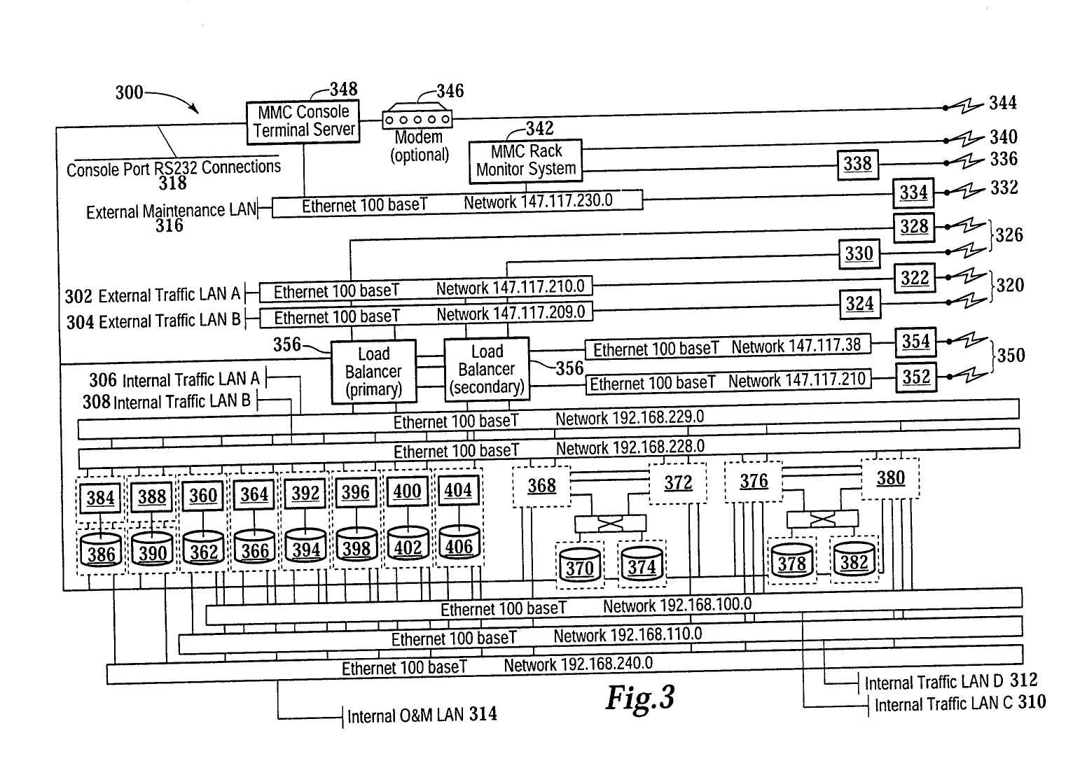

Referring now to FIG. 3, a block diagram showing the network connectivity MMS 300 having a load balancer in accordance with one embodiment of the present invention is shown. The MMS 300 has an external traffic LAN A 302, external traffic LAN B 304, internal traffic LAN A 306, internal traffic LAN B 308, internal traffic LAN C 310, internal traffic LAN D 312, internal O&M LAN 314, external maintenance LAN 316 and console port RS232 connections 318. A WAP Gateway 320 is communicably coupled to the external traffic LAN A 302 via WAN/LAN router/switch 322 and to external traffic LAN B 304 via WAN/LAN router/switch 324. An administration workstation 326 is communicably coupled to the external traffic LAN A 302 via WAN/LAN router/switch 328 and to external traffic LAN B 304 via WAN/LAN router/switch 330. A maintenance center 332 is communicably coupled to the external maintenance LAN 316 via WAN/LAN router/switch 334. A network operation center 336 is communicably coupled to a MMS rack monitor system 342 via WAN/LAN router/switch 338. MSC alarm node 340 is also communicably coupled to the MMS rack monitor system 342, which is communicably coupled to the external maintenance 316. A dial up connection 344 is provided to the MMS console terminal server 348 either directly or via an optional modem 346. The MMS console terminal server 348 is communicably coupled to the external maintenance LAN 316. A billing gateway 350 is communicably coupled to the primary load balancer 356 via WAN/LAN router/switch 352 and to secondary load balancer 358 via WAN/LAN router/switch 354.

The primary load balancer 356 is communicably coupled to the external traffic LAN A 302, external traffic LAN B 304, internal traffic LAN A 306, internal traffic LAN B 308, secondary load balancer 358 and console port RS232 connections 318. Similarly, the secondary load balancer 358 is communicably coupled to the external traffic LAN A 302, external traffic LAN B 304, internal traffic LAN A 306, internal traffic LAN B 308, primary load balancer 356 and console port RS232 connections 318. The MMS Relay 360 is communicably coupled to an applications database 362, internal traffic LAN A 306, internal traffic LAN B 308, internal traffic LAN C 310, internal traffic LAN D 312, internal O&M LAN 314 and console port RS232 connections 318. Similarly, the MMS Relay 364 is communicably coupled to an applications database 366, internal traffic LAN A 306, internal traffic LAN B 308, internal traffic LAN C 310, internal traffic LAN D 312, internal O&M LAN 314 and console port RS232 connections 318.

The MMS Subscriber Directory 368 is communicably coupled to subscriber database 370, MMS Subscriber Directory 372, subscriber database 374, internal traffic LAN A 306, internal traffic LAN B 308, internal O&M LAN 314 and console port RS232 connections 318. Similarly, the MMS Subscriber Directory 372 is communicably coupled to subscriber database 374, MMS Subscriber Directory 368, subscriber database 370, internal traffic LAN A 306, internal traffic LAN B 308, internal O&M LAN 314 and console port RS232 connections 318. The MMS Server 376 is communicably coupled to message storage 378, MMS Server 380, message storage 382, internal traffic LAN A 306, internal traffic LAN B 308, internal traffic LAN C 310, internal traffic LAN D 312, internal O&M LAN 314 and console port RS232 connections 318. Similarly, the MMS Server 380 is communicably coupled to message storage 382, MMS Server 376, message storage 378, internal traffic LAN A 306, internal traffic LAN B 308, internal traffic LAN C 310, internal traffic LAN D 312, internal O&M LAN 314 and console port RS232 connections 318.

The MMS O&M Server 384 is communicably coupled to database 386, MMS O&M Server 388, internal traffic LAN A 306, internal traffic LAN B 308, internal O&M LAN 314 and console port RS232 connection 318. Database 386 is also communicably to internal traffic LAN A 306, internal traffic LAN B 308, internal O&M LAN 314 and console port RS232 connection 318. Similarly, the MMS O&M Server 388 is communicably coupled to database 390, MMS O&M Server 384, internal traffic LAN A 306, internal traffic LAN B 308, internal O&M LAN 314 and console port RS232 connection 318. Database 390 is also communicably to internal traffic LAN A 306, internal traffic LAN B 308, internal O&M LAN 314 and console port RS232 connection 318. MMS Media Processor 392 is communicably coupled to applications database 394, internal traffic LAN A 306, internal traffic LAN B 308, internal traffic LAN C 310, internal traffic LAN D 312, internal O&M LAN 314 and console port RS232 connections 318. MMS Media Processor 396 is communicably coupled to applications database 398, internal traffic LAN A 306, internal traffic LAN B 308, internal traffic LAN C 310, internal traffic LAN D 312, internal O&M LAN 314 and console port RS232 connections 318. MMS Media Processor 400 is communicably coupled to applications database 402, internal traffic LAN A 306, internal traffic LAN B 308, internal traffic LAN C 310, internal traffic LAN D 312, internal O&M LAN 314 and console port RS232 connections 318. MMS Media Processor 404 is communicably coupled to applications database 406, internal traffic LAN A 306, internal traffic LAN B 308, internal traffic LAN C 310, internal traffic LAN D 312, internal O&M LAN 314 and console port RS232 connections 318.

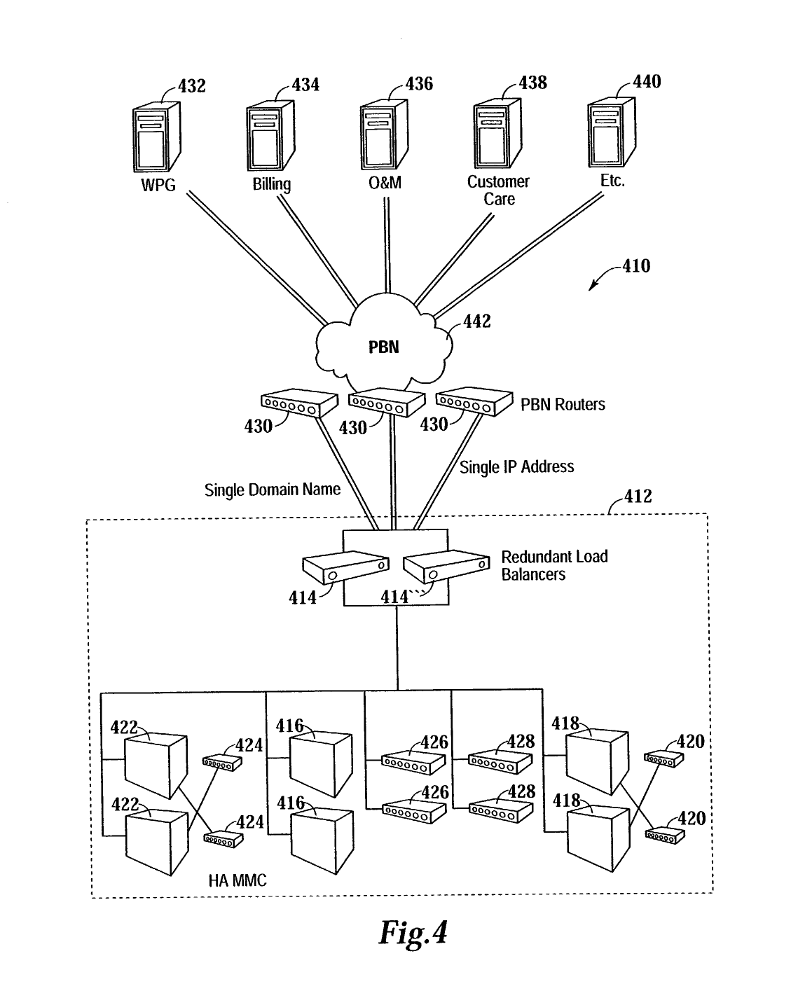

Now referring to FIG. 4, a block diagram showing a single site MMS 410 having a load balancer in accordance with one embodiment of the present invention is shown. HA MMC 412 contains two load balancers 414, two MMS Relays 416 communicably coupled to the load balancers 414, two MMS Servers 418 communicably coupled to the load balancers 414, two message storage devices 420 communicably coupled to the MMS Servers 418 and two MMS Subscriber Directories 422 (including subscriber database 424) communicably coupled to the load balancers 414. The redundant load balancers 414 are identified by a single domain name or IP address. The load balancers 414 are also communicably coupled to two MMS Media Processors 426 and two MMS O&M Servers 428. Redundant load balancers 414 are communicably coupled to one or more PBN routers 430, which provides an interface to WPG 432, Billing 434, O&M 436, Customer Care 438 and other Servers 440 via PBN 442.

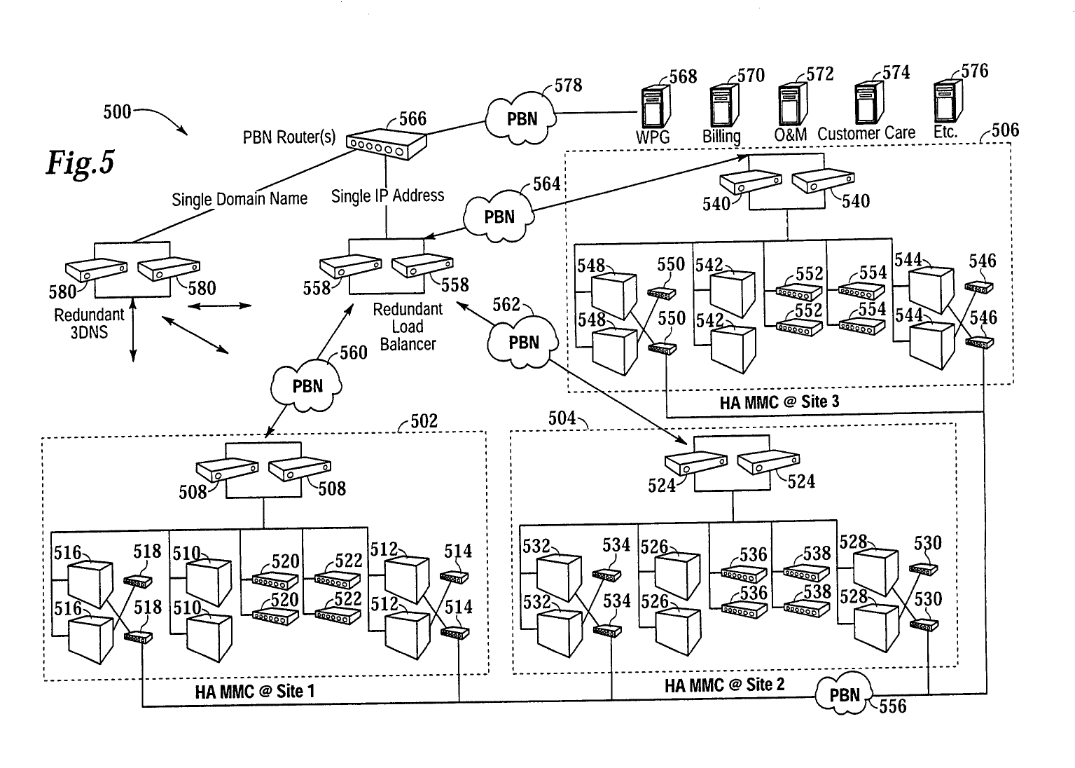

Referring now to FIG. 5, a block diagram showing a multiple site MMS 500 having a load balancer in accordance with one embodiment of the present invention is shown. More specifically, the MMS 500 has three separate and independent MMCs: HA MMC at site one 502; HA MMC at site two 504; and HA MMC at site three 506. HA MMC at site one 502 contains two load balancers 508, two MMS Relays 510 communicably coupled to the load balancers 508, two MMS Servers 512 communicably coupled to the load balancers 508, two message storage devices 514 communicably coupled to the MMS Servers 512 and two MMS Subscriber Directories 516 (including subscriber database 518) communicably coupled to the load balancers 508. The load balancers 508 are also communicably coupled to two MMS Media Processors 520 and two MMS O&M Servers 522.

Similarly, HA MMC at site two 504 contains two load balancers 524, two MMS Relays 526 communicably coupled to the load balancers 524, two MMS Servers 528 communicably coupled to the load balancers 524, two message storage devices 530 communicably coupled to the MMS Servers 512 and two MMS Subscriber Directories 532 (including subscriber database 534) communicably coupled to the load balancers 524. The load balancers 524 are also communicably coupled to two MMS Media Processors 536 and two MMS O&M Servers 536.

Finally, HA MMC at site three 506 contains two load balancers 540, two MMS Relays 542 communicably coupled to the load balancers 540, two MMS Servers 544 communicably coupled to the load balancers 540, two message storage devices 546 communicably coupled to the MMS Servers 544 and two MMS Subscriber Directories 548 (including subscriber database 550) communicably coupled to the load balancers 540. The load balancers 540 are also communicably coupled to two MMS Media Processors 552 and two MMS O&M Servers 554.

The MMS Subscriber Directories 516 (including subscriber database 518) and message storage devices 514 in HA MMC at site one 502, and MMS Subscriber Directories 532 (including subscriber database 534) and message storage devices 530 in HA MMC at site two 504, and MMS Subscriber Directories 548 (including subscriber database 550) and message storage devices 546 in HA MMC at site three 506 are communicably coupled together via PBN 556. In addition, the load balancers 508 in HA MMC at site one 502 are communicably coupled to redundant load balancers 558 via PBN 560, load balancers 524 in HA MMC at site two 504 are communicably coupled to redundant load balancers 558 via PBN 562, and load balancers 540 in HA MMC at site three 506 are communicably coupled to redundant load balancers 558 via PBN 564. Redundant load balancers 558 are communicably coupled to one or more PBN routers 566, which provides an interface to WPG 568, Billing 570, O&M 572, Customer Care 574 and other Servers 576 via PBN 578. The one or more PBN routers 566 are also communicably coupled to redundant 3DNS 580, which are in turn communicably coupled to LBs 582

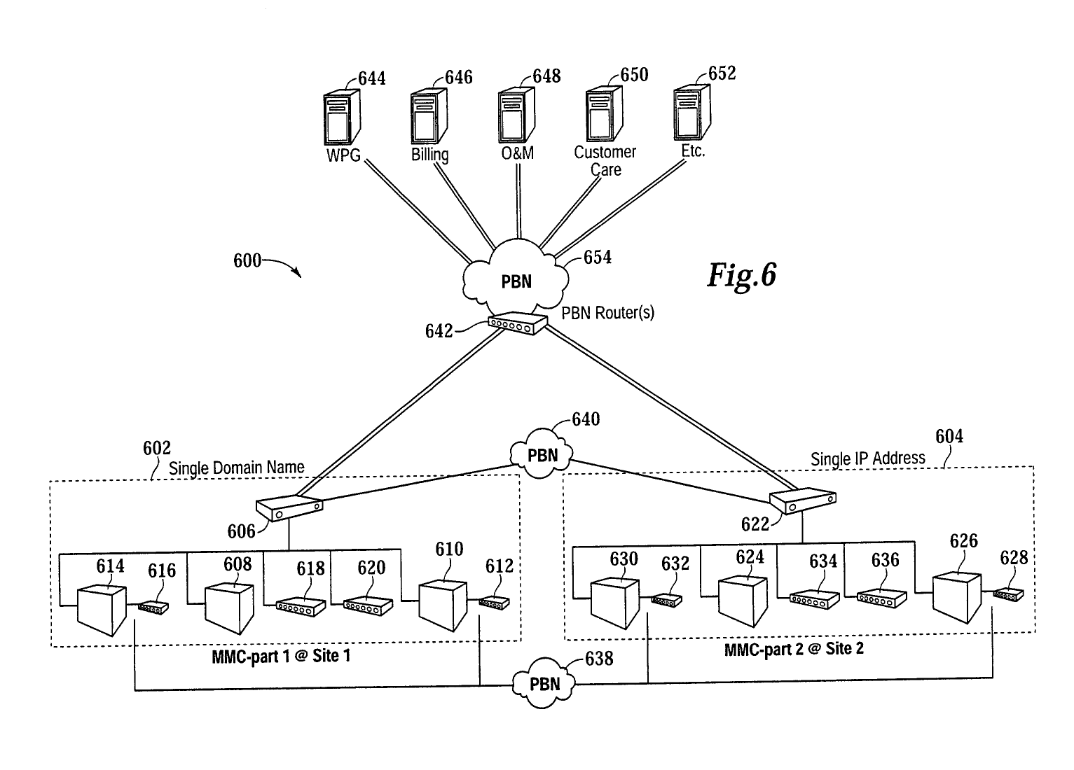

Now referring to FIG. 6, a block diagram showing a multiple site MMS 600 having a load balancer in accordance with another embodiment of the present invention is shown. More specifically, the MMC is split into two parts such that each part is located at a different site: MMC part one at site one 602; and MMC part two at site two 604. MMC part one at site one 602 contains a load balancer 606, a MMS Relay 608 communicably coupled to the load balancer 606, a MMS Server 610 communicably coupled to the load balancer 606, a message storage device 612 communicably coupled to the MMS Server 610 and a MMS Subscriber Directory 614 (including subscriber database 616) communicably coupled to the load balancer 606. The load balancer 606 is also communicably coupled to a MMS Media Processor 618 and a MMS O&M Server 620.

Similarly, MMC part two at site two 604 contains a load balancer 622, a MMS Relay 624 communicably coupled to the load balancer 622, a MMS Server 626 communicably coupled to the load balancer 622, a message storage device 628 communicably coupled to the MMS Server 626 and a MMS Subscriber Directory 630 (including subscriber database 632) communicably coupled to the load balancer 622. The load balancer 622 is also communicably coupled to a MMS Media Processor 634 and a MMS O&M Server 636.

The MMS Subscriber Directory 614 (including subscriber database 616) and message storage device 612 in MMC part on at site one 602 are communicably coupled to the MMS Subscriber Directory 630 (including subscriber database 632) and message storage device 628 in MMC part two at site two 604 via PBN 638. Likewise, the load balancer 606 in MMC part on at site one 602 is communicably coupled to the load balancer 622 in MMC part two at site two 604 via PBN 640. Load balancers 606 and 622 are also communicably coupled to one or more PBN routers 642, which provide an interface to WPG 644, Billing 646, O&M 648, Customer Care 650 and other Servers 652 via PBN 654.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method for balancing multimedia message loading within a network having two or more multimedia service relays and two more multimedia service servers, the method comprising the steps of:
receiving a multimedia message at an ingress/egress device for the network, the ingress/egress device communicably coupled to the two or more multimedia service relays and the two more multimedia service servers;
selecting one of the multimedia service relays to process the multimedia message;
sending the multimedia message to the selected multimedia service relay for processing;
receiving the processed multimedia message from the selected multimedia service relay;
selecting one of the multimedia service servers to store the multimedia message on a message storage device communicably coupled to the selected multimedia service server; and
sending the processed multimedia message to the selected multimedia service server.

2. The method as recited in claim 1, wherein the multimedia message is received from within the network.

3. The method as recited in claim 1, wherein the multimedia message is received from outside the network.

4. The method as recited in claim 1, wherein the ingress/egress device is a load balancer.

5. The method as recited in claim 1, wherein the ingress/egress device is identified by a single address.

6. The method as recited in claim 5, wherein the single address is a domain name.

7. The method as recited in claim 5, wherein the single address is an IP address.

8. The method as recited in claim 1, wherein the ingress/egress device provides a firewall between the network and one or more external networks.

9. The method as recited in claim 1, wherein the step of selecting a multimedia service relay is based on the locations of the two or more multimedia service relays.

10. The method as recited in claim 1, wherein the step of selecting a multimedia service relay is based on the loading of the two or more multimedia service relays.

11. The method as recited in claim 1, wherein the step of selecting a multimedia service relay is based on the operational status of the two or more multimedia service relays.

12. The method as recited in claim 1, wherein the step of selecting a multimedia service server is based on the locations of the two or more multimedia service servers.

13. The method as recited in claim 1, wherein the step of selecting a multimedia service server is based on the loading of the two or more multimedia service servers.

14. The method as recited in claim 1, wherein the step of selecting a multimedia service server is based on the operational status of the two or more multimedia service servers.

15. The method as recited in claim 1, wherein the steps of selecting a multimedia service relay and a multimedia service server are based on one or more rules.

16. The method as recited in claim 15, wherein the one or more rules are designed to maximize resource allocation within the network.

17. The method as recited in claim 15, wherein the one or more rules are designed to maximize resource utilization within the network.

18. The method as recited in claim 15, wherein the one or more rules include a disaster recovery plan.

19. The method as recited in claim 1, further comprising the step of determining whether the multimedia message satisfies one or more security criteria.

20. The method as recited in claim 19, further comprising the step of rejecting the multimedia message whenever the multimedia message fails to satisfy the one or more security criteria.

21. A computer program embodied on a computer readable medium for balancing multimedia message loading within a network having two or more multimedia service relays and two more multimedia service servers comprising:
a code segment adapted to receive a multimedia message at an ingress/egress device for the network, the ingress/egress device communicably coupled to the two or more multimedia service relays and the two more multimedia service servers;
a code segment adapted to select one of the multimedia service relays to process the multimedia message;
a code segment adapted to send the multimedia message to the selected multimedia service relay for processing;
a code segment adapted to receive the processed multimedia message from the selected multimedia service relay;
a code segment adapted to select one of the multimedia service servers to store the multimedia message on a message storage device communicably coupled to the selected multimedia service server; and
a code segment adapted to send the processed multimedia message to the selected multimedia service server.

22. The computer program as recited in claim 21, wherein the multimedia message is received from within the network.

23. The computer program as recited in claim 21, wherein the multimedia message is received from outside the network.

24. The computer program as recited in claim 21, wherein the ingress/egress device is a load balancer.

25. The computer program as recited in claim 21, wherein the ingress/egress device is identified by a single address.

26. The computer program as recited in claim 25, wherein the single address is a domain name.

27. The computer program as recited in claim 25, wherein the single address is an IP address.

28. The computer program as recited in claim 21, wherein the ingress/egress device provides a firewall between the network and one or more external networks.

29. The computer program as recited in claim 21, wherein the selection of the multimedia service relay is based on the locations of the two or more multimedia service relays.

30. The computer program as recited in claim 21, wherein the selection of the multimedia service relay is based on the loading of the two or more multimedia service relays.

31. The computer program as recited in claim 21, wherein the selection of the multimedia service relay is based on the operational status of the two or more multimedia service relays.

32. The computer program as recited in claim 21, wherein the selection of the multimedia service server is based on the locations of the two or more multimedia service servers.

33. The computer program as recited in claim 21, wherein the selection of the multimedia service server is based on the loading of the two or more multimedia service servers.

34. The computer program as recited in claim 21, wherein the selection of the multimedia service server is based on the operational status of the two or more multimedia service servers.

35. The computer program as recited in claim 21, wherein the selection of the multimedia service relay and the multimedia service server are based on one or more rules.

36. The computer program as recited in claim 35, wherein the one or more rules are designed to maximize resource allocation within the network.

37. The computer program as recited in claim 35, wherein the one or more rules are designed to maximize resource utilization within the network.

38. The computer program as recited in claim 35, wherein the one or more rules include a disaster recovery plan.

39. The computer program as recited in claim 21, further comprising a code segment adapted to determine whether the multimedia message satisfies one or more security criteria.

40. The computer program as recited in claim 39, further comprising a code segment adapted to reject the multimedia message whenever the multimedia message fails to satisfy the one or more security criteria.

41. An apparatus for balancing multimedia message loading within a network having two or more multimedia service relays and two more multimedia service servers comprising:
a communications interface for communicably coupling to the two or more multimedia service relays and the two more multimedia service servers;
a processor communicably coupled to the communications interface;
a memory communicably coupled to the processor;
the processor receiving a multimedia message via the communications interface, selecting one of the multimedia service relays to process the multimedia message, sending the multimedia message to the selected multimedia service relay for processing via the communications interface, receiving the processed multimedia message from the selected multimedia service relay via the communications interface, selecting one of the multimedia service servers to store the multimedia message, and sending the processed multimedia message to the selected multimedia service server via the communications interface.

42. The apparatus as recited in claim 41, wherein the apparatus is identified by a single address.

43. The apparatus as recited in claim 42, wherein the single address is a domain name.

44. The apparatus as recited in claim 42, wherein the single address is an IP address.

45. The apparatus as recited in claim 41, further comprising a firewall between the processor and another communications interface for communicably coupling to one or more external networks.

46. The apparatus as recited in claim 41, wherein the selection of the multimedia service relay is based on the locations of the two or more multimedia service relays.

47. The apparatus as recited in claim 41, wherein the selection of the multimedia service relay is based on the loading of the two or more multimedia service relays.

48. The apparatus as recited in claim 41, wherein the selection of the multimedia service relay is based on the operational status of the two or more multimedia service relays.

49. The apparatus as recited in claim 41, wherein the selection of the multimedia service server is based on the locations of the two or more multimedia service servers.

50. The apparatus as recited in claim 41, wherein the selection of the multimedia service server is based on the loading of the two or more multimedia service servers.

51. The apparatus as recited in claim 41, wherein the selection of the multimedia service server is based on the operational status of the two or more multimedia service servers.

52. The apparatus as recited in claim 41, wherein the selection of the multimedia service relay and the multimedia service server are based on one or more rules.

53. The apparatus as recited in claim 52, wherein the one or more rules are designed to maximize resource allocation within the network.

54. The apparatus as recited in claim 52, wherein the one or more rules are designed to maximize resource utilization within the network.

55. The apparatus as recited in claim 52, wherein the one or more rules include a disaster recovery plan.

56. The apparatus as recited in claim 41, wherein the processor further determines whether the multimedia message satisfies one or more security criteria.

57. The apparatus as recited in claim 56, wherein the processor further rejects the multimedia message whenever the multimedia message fails to satisfy the one or more security criteria.

58. A system for balancing multimedia message loading within a network comprising:
an ingress/egress device;
two or more multimedia service relays communicably coupled to the ingress/egress device;
two or more multimedia service servers communicably coupled to the ingress/egress device;
a message storage device communicably coupled to each multimedia service server; and
the ingress/egress device receives a multimedia message, selects one of the multimedia service relays to process the multimedia message, sends the multimedia message to the selected multimedia service relay for processing, receives the processed multimedia message from the selected multimedia service relay, selects one of the multimedia service servers to store the multimedia message on the message storage device, and sends the processed multimedia message to the selected multimedia service server.

59. The system as recited in claim 58, wherein the ingress/egress device is communicably coupled to one or more external networks.

60. The system as recited in claim 58, wherein the multimedia message is received from within the network.

61. The system as recited in claim 58, wherein the multimedia message is received from outside the network.

62. The system as recited in claim 58, wherein the ingress/egress device is a load balancer.

63. The system as recited in claim 58, wherein the ingress/egress device is identified by a single address.

64. The system as recited in claim 63, wherein the single address is a domain name.

65. The system as recited in claim 63, wherein the single address is an IP address.

66. The system as recited in claim 58, wherein the ingress/egress device provides a firewall between the network and one or more external networks.

67. The system as recited in claim 58, wherein the selection of the multimedia service relay is based on the locations of the two or more multimedia service relays.

68. The system as recited in claim 58, wherein the selection of the multimedia service relay is based on the loading of the two or more multimedia service relays.

69. The system as recited in claim 58, wherein the selection of the multimedia service relay is based on the operational status of the two or more multimedia service relays.

70. The system as recited in claim 58, wherein the selection of the multimedia service server is based on the locations of the two or more multimedia service servers.

71. The system as recited in claim 58, wherein the selection of the multimedia service server is based on the loading of the two or more multimedia service servers.

72. The system as recited in claim 58, wherein the selection of the multimedia service server is based on the operational status of the two or more multimedia service servers.

73. The system as recited in claim 58, wherein the selection of the multimedia service relay and a multimedia service server are based on one or more rules.

74. The system as recited in claim 73, wherein the one or more rules are designed to maximize resource allocation within the network.

75. The system as recited in claim 73, wherein the one or more rules are designed to maximize resource utilization within the network.

76. The system as recited in claim 73, wherein the one or more rules include a disaster recovery plan.

77. The system as recited in claim 58, wherein the ingress/egress device further determines whether the multimedia message satisfies one or more security criteria.

78. The system as recited in claim 77, wherein the ingress/egress device further rejects the multimedia message whenever the multimedia message fails to satisfy the one or more security criteria.
